(19) United States
(12) Patent Application Publication
(10) Pub. No.: US 2010/0072782 A1
(43) Pub. Date: Mar. 25, 2010

(54) MULTI-PURPOSE INTERIOR FOR CAB APPLICATIONS

(75) Inventors: Andrew E. Modzik, JR., Charlotte, NC (US); Ryan A. Jennings, Winston Salem, NC (US); Larry A. Sliker, Hewitt, NJ (US)

Correspondence Address: MICHAEL BEST & FRIEDRICH LLP, 100 E WISCONSIN AVENUE, Suite 3300, MILWAUKEE, WI, 53202, US

(73) Assignee: INGERSOLL-RAND COMPANY, Montvale, NJ (US)

(21) Appl. No.: 12/235,774

(22) Filed: Sep. 23, 2008

(51) Int. Cl. B62D 33/06

(52) U.S. Cl. 296/190.09

(57) ABSTRACT

An interior for a cab of a construction vehicle, the interior including a base, a seat mount formed as a part of the base, an air-conditioning component mount formed as a part of the base, a control mount formed as a part of the base, a duct formed as a part of the base that includes an inlet, an outlet, and a substantially enclosed space between the inlet and the outlet, and a storage compartment formed as a part of the base.

### BACKGROUND

The present invention relates to vehicle interiors. Specifically, the invention relates to cab interiors for industrial vehicles.

### SUMMARY

In one construction, the invention provides an interior for a cab of a construction vehicle. The interior includes a base, a seat mount formed as a part of the base, an air-conditioning component mount formed as a part of the base, a control mount formed as a part of the base, and a duct formed as a part of the base. The duct includes an inlet, an outlet, and a substantially enclosed space between the inlet and the outlet. A storage compartment is formed as a part of the base.

In another construction, the invention provides an interior for a cab of a vehicle. The interior includes a base and a seat mount formed as a part of the base and configured to support an operator's seat. An air-conditioning component mount is formed as a part of the base and is configured to support an air-conditioning component. A control mount is formed as a part of the base and is configured to support a control component. A duct is formed as part of the base and defines an inlet, an outlet, and a substantially enclosed space between the inlet and the outlet. A storage compartment is formed as a part of the base and is in selective fluid communication with the duct.

In yet another construction, the invention provides a wheel loader that includes a body, a plurality of wheels coupled to the body to support the body for movement, and a loader coupled to the body and movable between a first position and a second position. A cab is coupled to the body and a seat is positioned within the cab. A cab enclosure is positioned to surround and substantially enclose a cab space and an air-conditioning system is operable to provide conditioned air to the cab. The air-conditioning system includes a heat exchanger. A cab interior is formed as a single piece, is positioned to support the seat, and defines a duct, a storage compartment, and an exterior surface that defines a portion of an operator interface surface. The heat exchanger is supported by the cab interior and positioned at least partially within the duct to condition a flow of air passing through the duct, and a flow passage is defined by the cab interior to provide selective fluid communication between the duct and the storage compartment.

Other aspects of the invention will become apparent by consideration of the detailed description and accompanying drawings.

### BRIEF DESCRIPTION OF THE DRAWINGS

FIG. 1 is a perspective view of a vehicle that includes a multi-purpose interior.

FIG. 2 is a perspective view of a cab of the vehicle of FIG. 1.

FIG. 3 is a perspective view of a base of the multi-purpose interior of FIG. 1 positioned within the cab of FIG. 2.

FIG. 4 is a perspective view of an air-conditioning system.

FIG. 5 is a perspective view of the multi-purpose interior of FIG. 1.

FIG. 6 is a perspective view of the base of FIG. 3.

FIG. 7 is a bottom view of the base of FIG. 3.

FIG. 8 is a schematic view of the multi-purpose interior of FIG. 1.

### DETAILED DESCRIPTION

Before any constructions of the invention are explained in detail, it is to be understood that the invention is not limited in its application to the details of construction and the arrangement of components set forth in the following description or illustrated in the following drawings. The invention is capable of other constructions and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

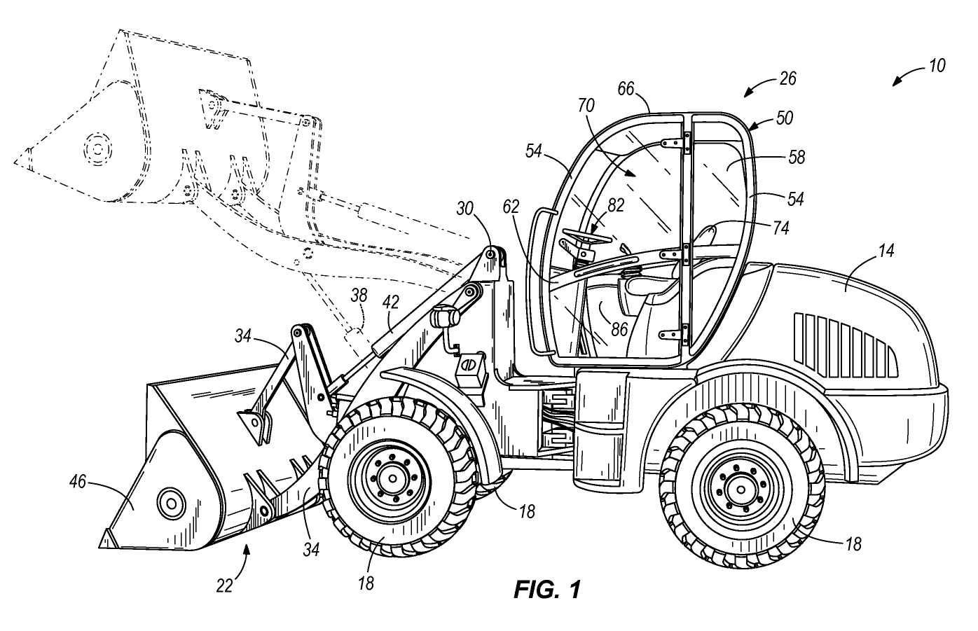

FIG. 1 shows a vehicle such as a construction vehicle or wheel loader 10 that includes a body 14, four wheels 18, a loader assembly 22, and a cab 26. The illustrated body 14 includes an engine compartment that houses an engine (not shown), a drive train (not shown), a suspension system (not shown), and various control systems as is known by those skilled in the art. The body 14 also includes front and rear axles (not shown) that are coupled to the wheels 18 such that the wheels 18 support the wheel loader 10 for movement. In addition, the body 14 includes loader mounts 30 that are coupled to the loader assembly 22.

The illustrated loader assembly 22 includes a loader linkage 34, a lift actuator 38, a dump actuator 42, and a loader or bucket 46. The lift actuator 38 acts on the loader linkage 34 to move the loader 46 from a first position shown in solid lines, to a second position shown in broken lines. The dump actuator 42 acts on the loader linkage 34 to move the loader 46 from the position shown in FIG. 1 to a dumped position. Wheel loaders 10 and their functionality are well known and will not be described in detail. One skilled in the art will understand that the particular arrangement of the illustrated wheel loader 10 is only one example of a wheel loader 10 and many other wheel loader arrangements may utilize the invention. The specific arrangement of the illustrated wheel loader 10 in no way limits the scope of the invention. In addition, the invention can be applied to construction vehicles other than wheel loaders (e.g., graders, dump trucks, fork trucks, etc.).

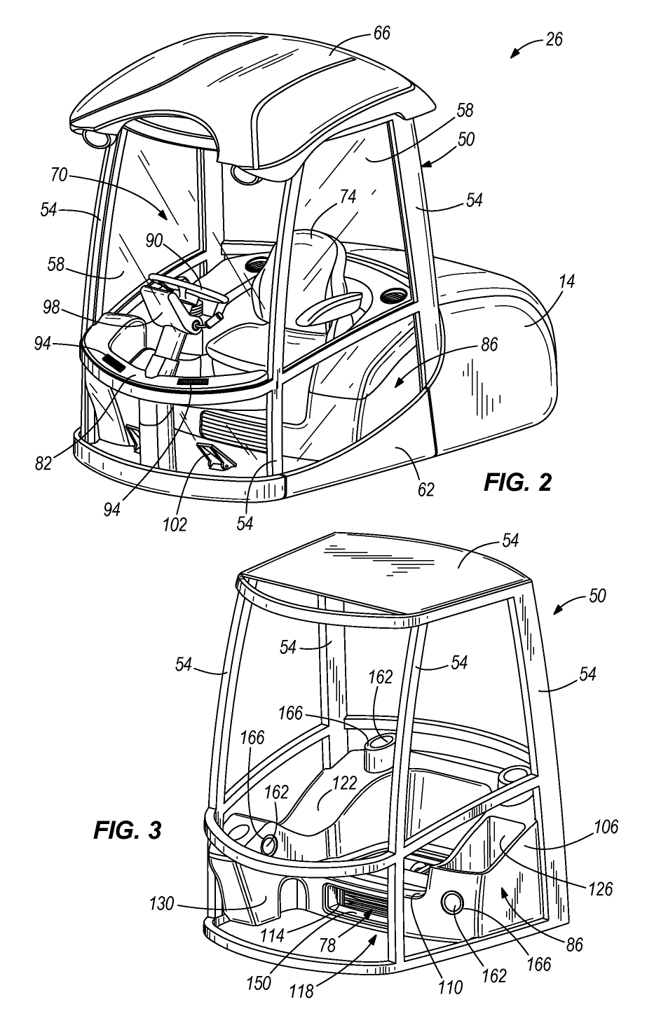

With reference to FIG. 2, the illustrated cab 26 includes a cab enclosure 50 with support members 54, windows 58, a door 62, and a roof 66. The illustrated cab enclosure 50 surrounds and substantially encloses a cab space 70 that may house an operator (not shown). The illustrated support members 54, windows 58, door 62, and roof 66 may be the same or different than illustrated and do not in any way limit the scope of the invention. In addition, some or all of the support members 54, windows 58, door 62, and roof 66 could be eliminated in some constructions if desired.

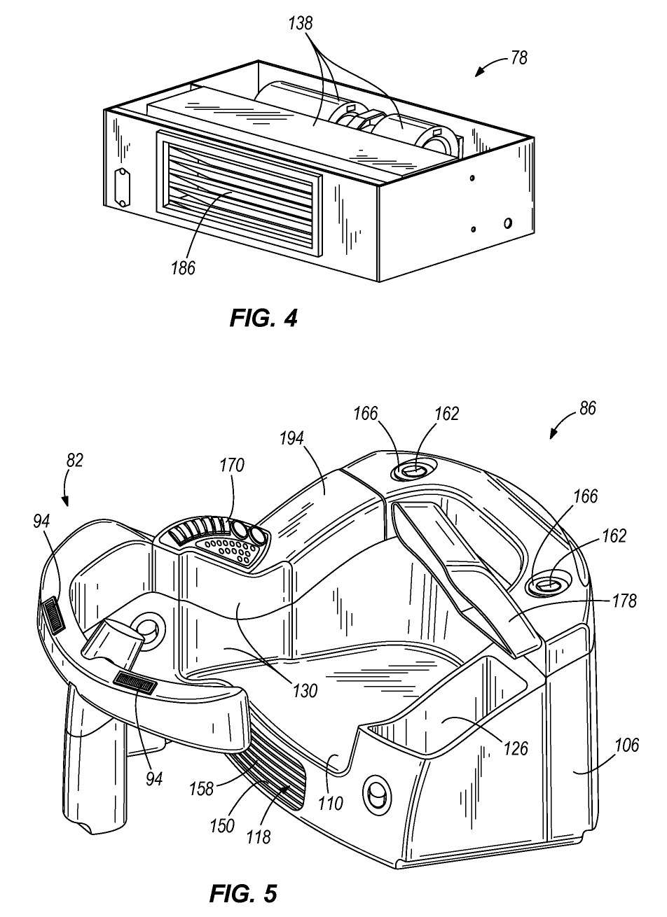

The illustrated cab space 70 includes an operator's seat 74, an air-conditioning system 78 (shown in FIG. 4), a front control panel 82, and a cab interior 86. The illustrated seat 74 is positioned within the cab 26 and supported by the cab interior 86 such that the operator may comfortably sit in the seat 74 and operate all the necessary controls of the wheel loader 10. In other constructions, the seat 74 is at least partially supported by the cab interior 86 and may have a different position within the cab 26. In addition, the seat 74 may be of a different design than illustrated.

The illustrated front control panel 82 includes a steering wheel 90, air-flow vents 94, and a gauge set 98. The steering wheel 90 controls the direction of travel of the wheel loader 10. The air-flow vents 94 direct conditioned air toward the operator or in another direction within the cab space 70 (e.g., the front window 58) to either heat, cool, or otherwise treat the air in the cab space 70. The gauge set 98 includes gauges that indicate operating parameters as is well known in the art. In addition, brake and acceleration pedals 102 may be included in the front control panel 82 to slow or accelerate the wheel loader 10. Brake and acceleration pedals 102 are well known and will not be discussed in detail. The front control panel 82 may have many different designs and configurations and the illustrated arrangement does not limit the scope of the invention. The invention may be practiced with many different control panel arrangements. In addition, the front control panel 82 may be removed such that the steering wheel 90, air-flow vents 94, gauge set 98, pedals 102, and other components may be supported by a different component of the cab 26, such as the cab interior 86.

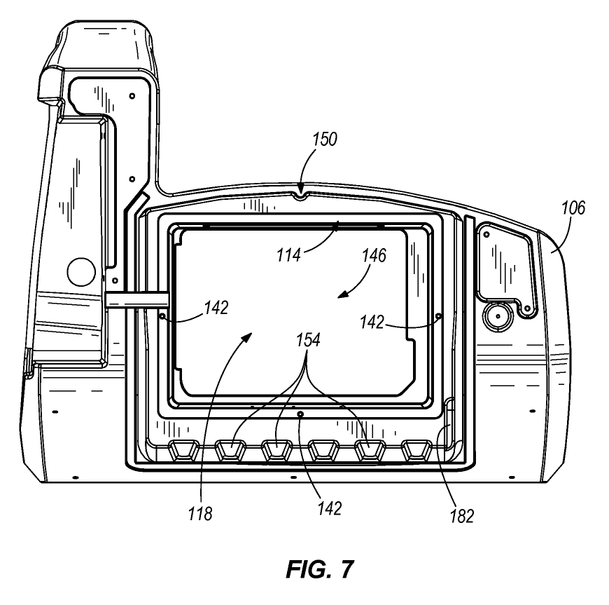

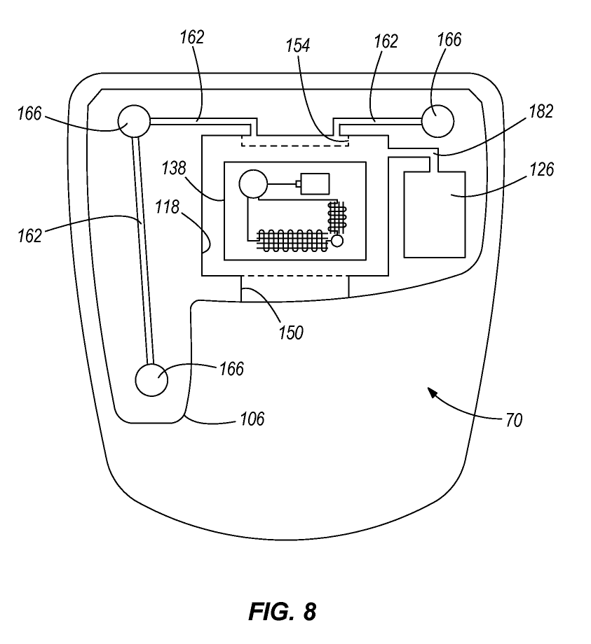

Referring to FIGS. 2 and 3, the illustrated cab interior 86 includes a base 106, a seat mount 110, an air-conditioning component mount 114 (shown in FIG. 7), a duct 118, a control mount 122, and a storage compartment 126. The illustrated seat mount 110, air-conditioning component mount 114, control mount 122, duct 118, and storage compartment 126 are formed as a single piece with the base 106 during a single molding process. One process that may be used to form the base 106 is rotational molding, although other processes may be used to form the base 106 if desired. The base 106 has an exterior surface 130 that defines a portion of an operator interface surface. The operator interface surface includes any part of the cab space 70 that the operator may directly interact with. Other components or mounts may be formed as a part of the base 106, if desired.

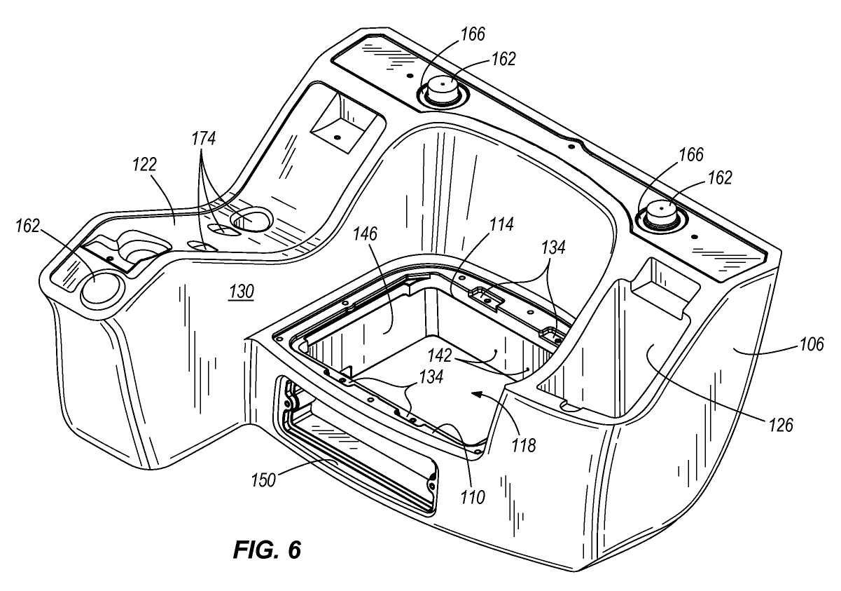

With reference to FIG. 6, the operator's seat 74 (see FIG. 2) engages the seat mount 110 such that the seat 74 is at least partially supported by the base 106 within the cab space 70. The operator's seat 74 is positioned such that the operator may easily access any components necessary to operate the wheel loader 10. The illustrated seat mount 110 includes four mounting recesses 134 that engage corresponding protrusions (not shown) of the seat 74. Fasteners (not shown) may engage the seat 74 and the seat mount 110 to fix the seat 74 to the seat mount 110. In the illustrated construction, the seat 74 is positioned within a generally rectangularly shaped space, although in other constructions the space may be shaped differently. In addition, a different number of recesses 134 may be utilized, or the seat mount 110 may include protrusions that engage corresponding recesses in the seat 74. Furthermore, the recesses 134 and protrusions may be removed and the fasteners may be used to position and hold the seat 74 in place with respect to the seat mount 110 without an recesses or protrusions. Thus, many different arrangements are available to attach the seat 74 to the base 106.

The illustrated air-conditioning component mount 114 engages and at least partially supports an air-conditioning system 78 (shown in FIG. 4) that includes an air-conditioning component 138 (e.g., a heat exchanger, a compressor, valves, pipes, tubes, reservoir, fans, etc.). The illustrated air-conditioning component mount 114 engages the air-conditioning system 78 with fasteners disposed through holes 142 in the air-conditioning component mount 114. The air-conditioning component mount 114 positions the air-conditioning system 78 under the seat 74 and at least partially within a substantially enclosed space 146 of the duct 118. In other constructions, the air-conditioning component mount 114 may be arranged differently or may position the air-conditioning system 78 in a different location.

As illustrated in FIG. 6, the duct 118 is formed in the base 106 and includes an inlet 150 and an outlet 154 in addition to the enclosed space 146 that houses the air-conditioning system 78. The inlet 150 may be covered with a protective vent plate 158 that engages the base 106. Air may flow through the inlet 150 and into the enclosed space 146 where the air may be utilized by the air-conditioning system 78. The conditioned air is exhausted from the air-conditioning system 78 and flows through the outlet 154. The inlet 150, the enclosed space 146, and the outlet 154 are in fluid communication such that the duct 118 is substantially sealed except for the inlet 150 and outlet 154. The outlet 154 includes multiple apertures and is best shown in FIG. 7. In other constructions, the duct 118 may be formed differently or may be located in a different location within the base 106.

As illustrated in FIGS. 5 and 6, the base 106 includes a plurality of vent ducts 162 that are in fluid communication with the outlet 154 and provide a passageway for conditioned air to pass into various areas of the cab space 70. The illustrated vent ducts 162 interconnect the outlet 154 with several vent outlets 166 spaced around the base 106. The illustrated base 106 includes two vent outlets 166 near the rear of the cab space 70, two vent outlets 166 near the middle of the cab space 70, and a vent outlet 166 near the front of the base 106 that may connect to the air-flow vents 94 of the front control panel 82. In other constructions, more or fewer vent ducts 162 of the same or different arrangement may be formed in the base 106. Furthermore, the vent outlets 166 are formed separately, although the vent outlets 166 could be formed as a single piece with the vent ducts 162.

As illustrated in FIG. 6, the control mount 122 is formed in the right side of the base 106 and provides a mounting location to support a control component 170 (shown in FIG. 5) such as an air-conditioning system control or a loader assembly control. Three apertures 174 are provided to allow cables and other control wiring (not shown) to pass through the base 106 to other portions of the wheel loader 10. The control component 170 may control many operations of the wheel loader 10 such as movement of the loader assembly 22, operation of the air-conditioning system 78, as well as other operations. In addition, the control component 170 may include multiple control components 170 (e.g., the air-conditioning control, the loader assembly control, lighting control, etc.) and may include various gauges or other components if desired.

With continued reference to FIG. 6, the storage compartment 126 is formed as part of the base 106 and includes walls that provide a space for the operator to store items (e.g., a lunch). A lid 178 covers the storage compartment 126 and is movable between an open position (shown in FIG. 5) where access to the storage compartment 126 is provided, and a closed position (shown in FIGS. 1 and 2) where access to the storage compartment 126 is inhibited. The illustrated storage compartment 126 is in selective thermal communication with the duct 118 such that fluid communication exists between the storage compartment 126 and the duct 118. In other constructions, the storage compartment 126 may be in communication with the duct 118 via a heat exchanger or other thermal transfer device (not shown) such that fluid communication between the duct 118 and the storage compartment 126 is inhibited but thermal communication is encouraged. In addition, a louver or control component 170 may be used to provide selective communication (thermal or fluid) between the duct 118 and the storage compartment 126. In one construction, the control component 170 may be manually operated. In other constructions, the control component 170 may vary a fluid flow through the flow passage 182 or adjust the thermal communication between the duct 118 and the storage compartment 126 to maintain a desired temperature within the storage compartment 126. Other control components may be used to vary the communication (fluid or thermal) between the storage compartment 126 and the duct 118, if desired.

One construction of the air-conditioning system 78 is shown in FIG. 4 and includes an air-conditioning component 138 and a filter 186. The air-conditioning system 78 receives a flow of air from the inlet 150 of the duct 118, conditions the air (i.e., heats, cools, dries, humidifies, filters, etc.), and exhausts the air to the outlet 154 of the duct 118 from which the air is directed to the vent outlets 166 via the vent ducts 162. The filter 186 may be a particulate filter, a gaseous state filter, a UV filter or any other type of filter desired. The filter 186 and the air-conditioning component 138 are controlled by the control component 170 such that a desired temperature and/or air quality is maintained within the cab space 70. In other constructions, the filter 186 or the air-conditioning component 138 may be removed. In addition, the air-conditioning system 78 may have a different arrangement or may be controlled manually without the use of the control component 170 if desired.

In addition to the base 106, the cab interior 86 may include a foam layer 194 bonded to a portion of the base 106. The foam layer 194 adds additional padding and comfort for the operator and adds an attractive look to the cab 26. The foam layer 194 may be a different color than the base 106 and remaining portions of the cab interior 86 if desired. The base 106 itself may also be formed of two different colored plastics such that multiple colors are visible within the cab space 70. In other embodiments, the foam layer may be eliminated.

Various features and advantages of the invention are set forth in the following claims.

What is claimed is:

1. An interior for a cab of a construction vehicle, the interior comprising:
a base;
a seat mount formed as a part of the base;
an air-conditioning component mount formed as a part of the base;
a control mount formed as a part of the base;
a duct formed as a part of the base and including an inlet, an outlet, and a substantially enclosed space between the inlet and the outlet; and
a storage compartment formed as a part of the base.

2. The interior of claim 1, wherein the base, the seat mount, the air-conditioning component mount, the control mount, the duct, and the storage compartment are formed as a single piece during a single forming operation.

3. The interior of claim 1, further comprising a foam layer bonded to a portion of the base.

4. The interior of claim 1, wherein the base includes portions constructed of two different colored plastics.

5. The interior of claim 1, wherein the air-conditioning component mount engages and at least partially supports a heat exchanger.

6. The interior of claim 5, wherein the heat exchanger is in thermal communication with the duct.

7. The interior of claim 1, further comprising a filter coupled to the air-conditioning component mount.

8. The interior of claim 1, wherein the storage compartment is in selective thermal communication with the duct.

9. The interior of claim 1, further comprising a plurality of vent ducts each defining a vent outlet, each vent duct in fluid communication with the duct.

10. The interior of claim 1, wherein a seat engages the seat mount such that the seat is at least partially supported by the base.

11. An interior for a cab of a vehicle, the interior comprising:
a base;
a seat mount formed as a part of the base and configured to support an operator's seat;
an air-conditioning component mount formed as a part of the base and configured to support an air-conditioning component;
a control mount formed as a part of the base and configured to support a control component;
a duct formed as part of the base and defining an inlet, an outlet, and a substantially enclosed space between the inlet and the outlet; and
a storage compartment formed as a part of the base and in selective fluid communication with the duct.

12. The interior of claim 11, wherein the base, the seat mount, the air-conditioning component mount, the control mount, the duct, and the storage compartment are formed as a single piece during a single forming operation.

13. The interior of claim 11, further comprising a foam layer bonded to a portion of the base.

14. The interior of claim 11, wherein the air-conditioning component includes a heat exchanger.

15. The interior of claim 11, wherein the air-conditioning component is in thermal communication with the duct.

16. The interior of claim 11, wherein the air-conditioning component includes a filter.

17. The interior of claim 11, further comprising a plurality of vent ducts each defining a vent outlet, each vent duct in fluid communication with the duct.

18. A wheel loader comprising:
a body;
a plurality of wheels coupled to the body to support the body for movement;
a loader coupled to the body and movable between a first position and a second position;
a cab coupled to the body;
a seat positioned within the cab;
a cab enclosure positioned to surround and substantially enclose a cab space;
an air-conditioning system operable to provide conditioned air to the cab, the air-conditioning system including a heat exchanger;
a cab interior formed as a single piece and positioned to support the seat, the cab interior defining a duct, a storage compartment, and an exterior surface that defines a portion of an operator interface surface, the heat exchanger supported by the cab interior and positioned at least partially within the duct to condition a flow of air passing through the duct; and
a flow passage defined by the cab interior to provide selective fluid communication between the duct and the storage compartment.

19. The wheel loader of claim 18, wherein the cab interior including the duct, the storage compartment, the exterior surface, and the flow passage formed during a single forming operation.

20. The wheel loader of claim 18, further comprising a control component mounted to the cab interior.

21. The wheel loader of claim 18, wherein the air-conditioning system includes a filter.

22. The wheel loader of claim 18, further comprising a plurality of vent ducts each defining a vent outlet, each vent duct in fluid communication with the duct.

23. The wheel loader of claim 18, wherein the cab interior includes portions formed of two different colored plastics.
